(19) United States
(12) Patent Application Publication
(10) Pub. No.: US 2008/0118730 A1
(43) Pub. Date: May 22, 2008

(54) BIAXIALLY ORIENTED FILM, LAMINATES MADE THEREFROM, AND METHOD

(76) Inventors: Ta-Hua Yu, Woodbury, MN (US); James M. White, Niskayuna, NY (US); Sapna Blackburn, Mt. Vernon, IN (US); Irene Dris, Raritan, NJ (US); Kapil Sheth, Evansville, IN (US); Kevin Durocher, Waterford, NY (US); Safwat Tadros, (US)

Correspondence Address: SABIC - 08CS - STRUCTURED PRODUCTS;SABIC Innovative Plastics - IP Legal, ONE PLASTICS AVENUE, PITTSFIELD, MA, 01201-3697, US

(21) Appl. No.: 11/562,513

(22) Filed: Nov. 22, 2006

(51) Int. Cl. B32B 27/06; B29C 55/12; C25D 3/56; B29C 65/02

(52) U.S. Cl. 428/220; 156/309.9; 205/238; 264/291; 427/295; 428/473.5

(57) ABSTRACT

Disclosed is a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm. Also disclosed is a biaxially oriented monolithic film comprising a polyimide with structural units formally derived from 3,4-diaminodiphenylether and 4,4-oxydiphthalic anhydride. Laminates comprising the films and methods for making film and laminate are also disclosed. Articles comprising a film or laminate of the invention are also disclosed.

### BACKGROUND

The present invention relates to biaxially oriented polyimide-comprising films laminates made therefrom, and methods for making.

The manufacturing process for flexible printed circuit boards normally involves several processes including change in temperature and generation of stress. It is therefore essential that any polymeric insulating film used as base substrate or coverlay undergo little change in dimension and exhibit resistance to heat when it is subjected to a stress or temperature change. However a simple solution to fulfill these requirements has not been obtained in the prior art. Commercially available examples of polyimide films are KAPTON® and UPILEX®. Because typical polyimides are not sufficiently thermoplastic, these films are typically made by a solution casting method where a polyamic acid solution is cast and stretched, the solvent is removed, and the residual film is heat-treated, for example as described in U.S. Pat. Nos. 5,324,475, 5,460,890, and 6,548,180. More recent work teaches the direct casting of polyamic acid solution onto copper foils followed by curing and drying at elevated temperatures, for example as described in published U.S. Patent Application No. 2005/0112362. These technologies require a solvent casting process that is expensive, time consuming, and involve toxic organic solvents. U.S. Pat. No. 5,260,407 describes a process wherein a polyimide is melt extruded to cast film on a chill-roller. The extruded film is then stretched either uniaxially or biaxially followed by heat-setting. The final articles did not address the necessary requirement of balanced low coefficient of thermal expansion (CTE) for lamination to copper foils for flexible printed circuit applications.

Flexible printed circuits (FPC) have been adapted into numerous electronic applications. Most FPCs are laminates made of a dielectric layer such as a polyimide film, an adhesive layer, and a conductive layer such as copper. However, for highly demanding applications the adhesive layer can cause performance and aging issues, and reduce the reliability of the circuit. For these applications it is necessary to overcome the problems associated with use of an adhesive to improve part reliability.

There is a need for laminates comprising metal foil and thermoplastic resin film and a method to prepare the laminates, which laminates and method overcome the problems of the prior art such as curling and part distortion due to mismatch in CTE between foil and film. There is also a need for laminates which overcome problems that may be associated with use of an adhesive. There is also a need for a method to form biaxially oriented films which does not rely solely on a solution casting process.

### BRIEF DESCRIPTION

The present inventors have discovered polyimide-comprising compositions which overcome limitations imposed by the prior art. In one embodiment the invention comprises a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm.

In another embodiment the invention comprises a biaxially oriented monolithic film comprising a polyimide with structural units formally derived from 3,4-diaminodiphenylether and 4,4-oxydiphthalic anhydride.

In still another embodiment the invention comprises a method to make a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, the thickness of the film is in a range of between 5 μm and 125 μm, and the difference in CTE in the transverse direction differs from the CTE in the machine direction by less than about 15 ppm/° C., wherein the method comprises the steps of (i) assembling a multilayer A-B or A-B-A film, (ii) biaxially stretching the multilayer film simultaneously or sequentially, and (iii) relaxing and annealing the film.

In still another embodiment the invention comprises a laminate comprising (i) a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm, and (ii) a conductive layer, wherein the conductive layer is in contact with the layer A of the multilayer film

In still another embodiment the invention comprises a laminate comprising (i) a biaxially oriented monolithic film comprising a polyimide with structural units formally derived from 3,4-diaminodiphenylether and 4,4-oxydiphthalic anhydride, and (ii) a conductive layer.

In still another embodiment the invention comprises a method for preparing a laminate comprising (i) a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm, and (ii) a conductive layer comprising a metal selected from the group consisting of copper, zinc, brass, chrome, nickel, aluminum, stainless steel, iron, gold, silver, titanium, combinations thereof, and alloys thereof, wherein the method comprises thermally laminating the multilayer film and a metal foil, or metallizing the multilayer film using vacuum deposition or electrodeposition, wherein the metal is in contact with the layer A of the multilayer film.

Articles comprising a film or laminate of the invention are also encompassed. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. When structural units of chemical moieties are said to be formally derived from one or more precursor moieties in the following application, there is no implied limitation on the actual chemical reaction which may be used to produce the chemical moiety. For example when a chemical moiety such as a polyetherimide is said to have structural units formally derived from a dianhydride and a diamine as precursors, then any known method could be used to prepare the polyetherimide including reaction of a dianhydride and a diamine, or a displacement reaction between a phenoxide species and an imide bearing a displaceable group, or other known method, it only being necessary that the chemical moiety comprise structural units which may be represented in the stated precursor moiety.

One embodiment of the invention comprises a biaxially oriented monolithic film comprising a single type of polyimide resin. Another embodiment of the invention comprises a biaxially oriented multilayer film comprising two or more layers, at least one of which layers comprises a polyimide resin. Illustrative examples of such multilayer films comprise those with the structures A-B and A-B-A, wherein A and B represent separate layers, and at least one of A or B represents a layer comprising a polyimide resin and the other of A and B represents a layer of a different thermoplastic resin which optionally could be a different polyimide resin. Within the present context a different polyimide resin, for example polyimide “B”, comprises one having similar main-chain structural units but different end-groups from polyimide “A”, or one having similar structural units but a different molecular weight from polyimide “A”, or one having similar structural units but a different melt viscosity from polyimide “A”, or one having at least one different type of structural unit from polyimide “A”, or like examples.

Illustrative examples of suitable polyimides comprise those comprising structural units of the formula (I):

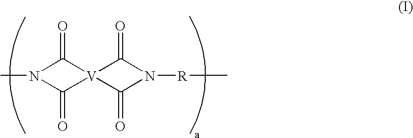

wherein “a” has a value of greater than 1, typically about 10 to about 1000 or more, and more specifically about 10 to about 500; V is a tetravalent linker without limitation, as long as the linker does not impede synthesis or use of the polyimide; and R is a substituted or unsubstituted divalent organic radical. Suitable linkers include but are not limited to: (a) substituted or unsubstituted, saturated, unsaturated or aromatic monocyclic or polycyclic groups having about 5 to about 50 carbon atoms, (b) substituted or unsubstituted, linear or branched, saturated or unsaturated alkyl groups having 1 to about 30 carbon atoms; or combinations of (a) and (b). Suitable substitutions and/or linkers include, but are not limited to, ethers, epoxides, amides, esters, and combinations comprising at least one of the foregoing. At least a portion of the linkers V contain a portion derived from a bisphenol. Desirably linkers include but are not limited to tetravalent aromatic radicals of formulas (II):

### (II)

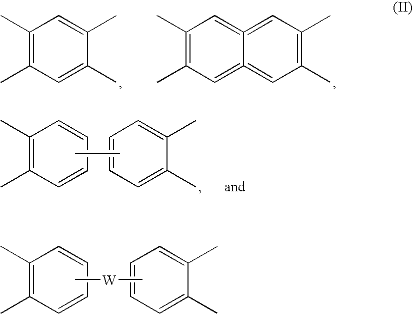

wherein W is a divalent moiety including —O—, —S—, —C(O)—, —SO₂—, —SO—, —C_{y}H_{2y}— (y being an integer from 1 to 5), and halogenated derivatives thereof, including perfluoroalkylene groups, or a group of the formula —O-Z-O—, wherein the divalent bonds of the —O— or the —O-Z-O— group are in the 3,3′, 3,4′, 4,3′, or the 4,4′ positions.

In some embodiments the moiety “Z” is a divalent aromatic group derived from a dihydroxy substituted aromatic hydrocarbon, and has the general formula (III):

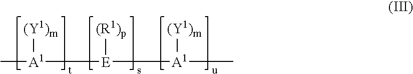

where “A¹” represents an aromatic group including, but not limited to, phenylene, biphenylene, naphthylene, and the like. In some embodiments, “E” may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments, when “E” is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments, “E” may be a cycloaliphatic group non-limiting examples of which include cyclopentylidene, cyclohexylidene, 3,3,5-trimethylcyclohexylidene, methylcyclohexylidene, bicyclo[2.2.1]hept-2-ylidene, 1,7,7-trimethylbicyclo[2.2.1]hept-2-ylidene, isopropylidene, neopentylidene, cyclopentadecylidene, cyclododecylidene, and adamantylidene; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence represents a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in a dihaloalkylidene group of formula C═C(Z¹)₂, wherein each Z¹ is independently hydrogen, chlorine, or bromine, subject to the provision that at least one Z¹ is chlorine or bromine; and mixtures of the foregoing moieties. In a particular embodiment the dihaloalkylidene group is a dichloroalkylidene, particularly a gem-dichloroalkylidene group. Y¹ independently at each occurrence may be a non-carbon atom including, but not limited to, halogen (fluorine, bromine, chlorine, iodine); an inorganic group containing more than one non-carbon atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl, it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of positions on A¹ available for substitution; “p” represents an integer from and including zero through the number of positions on E available for substitution; “t” represents an integer equal to at least one; “s” represents an integer equal to either zero or one; and “u” represents any integer including zero.

When more than one Y¹ substituent is present in formula (III), they may be the same or different. The same holds true for the R¹ substituent. Where “s” is zero in formula (III) and “u” is not zero, the aromatic rings are directly joined by a covalent bond with no intervening alkylidene or other bridge group. The positions of the oxygen groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and oxygen groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of the moiety “Z”, the moiety “E” may comprise an unsaturated alkylidene group. Suitable dihydroxy-substituted aromatic hydrocarbons from which “Z” may be derived in this case include those of the formula (IV):

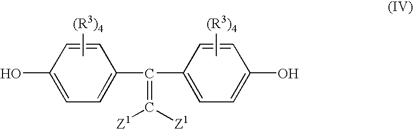

where each R³ is independently at each occurrence hydrogen, chlorine, bromine, or a C₁₋₃₀ monovalent hydrocarbon or hydrocarbonoxy group, and each Z¹ is hydrogen, chlorine or bromine, subject to the provision that at least one Z¹ is chlorine or bromine.

Examples of the moiety “Z” also include those derived from the dihydroxy-substituted aromatic hydrocarbons of the formula (V):

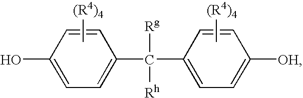

where each R⁴ is independently hydrogen, chlorine, bromine, or a C₁₋₃₀ monovalent hydrocarbon or hydrocarbonoxy group, and R^{g} and R^{h} are independently hydrogen or a C₁₋₃₀ hydrocarbon group.

In various embodiments of the present invention the moiety “Z” may be derived from dihydroxy-substituted aromatic hydrocarbons disclosed by name or formula (generic or specific) in U.S. Pat. Nos. 2,991,273, 2,999,835, 3,028,365, 3,148,172, 3,271,367, and 3,271,368. In some embodiments of the invention, such dihydroxy-substituted aromatic hydrocarbons include bis(4-hydroxyphenyl)sulfide, 1,4-dihydroxybenzene, 4,4′-oxydiphenol, 2,2-bis(4-hydroxyphenyl)hexafluoropropane, and mixtures of the foregoing dihydroxy-substituted aromatic hydrocarbons. In other embodiments such dihydroxy-substituted aromatic hydrocarbons include 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxy-phenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; resorcinol; C₁₋₃ alkyl-substituted resorcinols; 2,2-bis(4-hydroxyphenyl)butane; 2,2-bis(4-hydroxyphenyl)-2-methylbutane; 1,1-bis(4-hydroxyphenyl)cyclohexane; bis(4-hydroxyphenyl); 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; and bis(3,5-dimethylphenyl-4-hydroxyphenyl)sulfide. In some embodiments suitable dihydroxy-substituted aromatic hydrocarbons further comprise functionality selected from the group consisting of ethers, alkoxys, aryloxys, sulfones, perfluoroalkyl groups and mixtures thereof. In a particular embodiment such a dihydroxy-substituted aromatic hydrocarbon from which Z may be derived comprises bisphenol-A.

In some embodiments “Z” may be derived from dihydroxy-substituted aromatic hydrocarbons wherein “E” is an alkylene or alkylidene group and is part of one or more fused rings attached to one or more aromatic groups bearing one oxygen substituent. Suitable dihydroxy-substituted aromatic hydrocarbons of this type include those containing indane structural units such as 3-(4-hydroxyphenyl)-1,1,3-trimethylindan-5-ol and 1-(4-hydroxyphenyl)-1,3,3-trimethylindan-5-ol. Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols, illustrative examples of which include 2,2,2′,2′-tetrahydro-3,3,3′,3′-tetramethyl-1,1′-spirobi[1H-indene]-6,6′-diol (sometimes known as “SBI”). The structures —O-Z-O— derived from dihydroxy-substituted aromatic hydrocarbons may comprise mixtures of structural units derived from mixtures comprising any of the foregoing dihydroxy-substituted aromatic hydrocarbons.

In some particular embodiments Z includes, but is not limited, to divalent radicals of formula (VI):

### (VI)

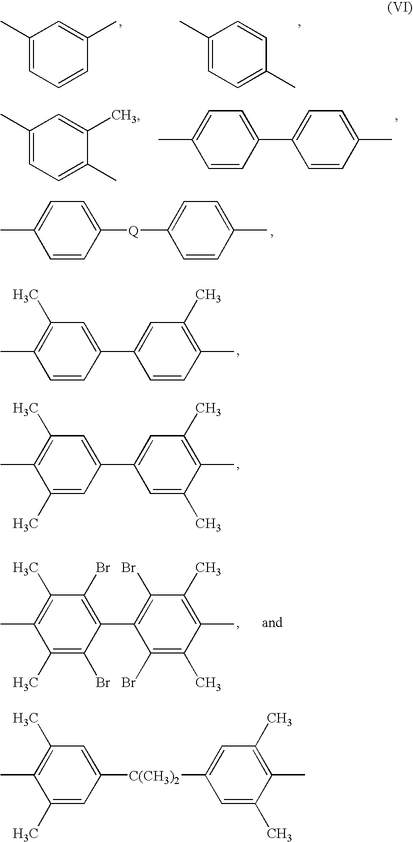

wherein Q includes but is not limited to a divalent moiety including —O—, —S—, —C(O)—, —SO₂—, —SO—, —C_{y}H_{2y}— (y being an integer from 1 to 5), and halogenated derivatives thereof, including perfluoroalkylene groups such as but not limited to —C(CF₃)₂—.

In some particular embodiments the moiety R in formula (I) comprises substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (VII):

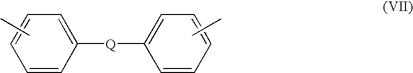

wherein Q includes but is not limited to a divalent moiety including a covalent bond, —O—, —S—, —C(O)—, —SO₂—, C_{y}H_{2y}— (y being an integer from 1 to 5), and halogenated derivatives thereof, including perfluoroalkylene groups such as but not limited to —C(CF₃)₂—, and wherein the variable linking bonds shown in formula (VII) are in the 3,3′, 3,4′, 4,3′, or the 4,4′ positions.

In other particular embodiments the moiety R is formally derived from at least one diamine. Any diamino compound may be employed. Illustrative examples of suitable diamines comprise ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 2,11-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis(4-aminocyclohexyl)methane, bis(4-aminobutyl)tetramethyldisiloxane, and 1,3-bis(3-aminopropyl)tetramethyldisiloxane.

The preferred diamino compounds from which the moiety R may be formally derived are aromatic diamines. Illustrative examples of suitable aromatic diamines comprise meta-phenylenediamine, para-phenylenediamine, 2,6-diethyl-4-methyl-1,3-phenylenediamine, 2,4-diaminotoluene, 2,6-diaminotoluene, 2,6-bis(mercaptomethyl)-4-methyl-1,3-phenylenediamine, 4,6-bis(mercaptomethyl)-2-methyl-1,3-phenylenediamine, bis(2-chloro-4-amino-3,5-diethylphenyl)methane, 4,4′-oxydianiline, 3,4′-oxydianiline, 3,3′-oxydianiline, 1,2-bis(4-aminophenyl)cyclobutene-3,4-dione, bis(aminophenoxy)benzene, 1,3-bis(3-aminophenoxy)benzene, 1,3-bis(4-aminophenoxy)benzene, 1,4-bis(4-aminophenoxybenzene), 3,3′-diaminodiphenylsulfone, 4,4′-diaminodiphenylsulfone, 3,4′-diaminodiphenylsulfone, bis(aminophenoxy)phenyl sulfone, bis(4-(4-aminophenoxy)phenyl)sulfone, bis(4-(3-aminophenoxy)phenyl)sulfone, bis(aminophenoxy)biphenyl, 4,4′-bis(3-aminophenoxy)biphenyl, 4,4′-bis(4-aminophenoxy)biphenyl, 2,2′-bis(4-(4-aminophenoxy)phenyl)propane, 2,2-bis[4-(4-aminophenoxy)phenyl]hexafluoropropane, 4,4′-bis(aminophenyl)hexafluoropropane, 3,3′-diaminobenzophenone, bis(aminophenoxy)benzophenone, 4,4′-diaminodiphenylmethane, 4,4′-diaminodiphenyl ether, 3,3′-diaminodiphenylmethane, benzidine, 3,3′-dimethylbenzidine, 3,3′-dimethoxybenzidine, 4,4′-diaminodiphenylsulfide, bis(4-aminophenyl)propane, 2,2′-bis(4-aminophenyl)propane, bis(p-beta-methyl-o-aminophenyl)benzene, 1,3-diamino-4-isopropylbenzene, 1,2-bis(3-aminophenoxy)ethane, diaminobenzanilide, bis(p-beta-amino-t-butylphenyl)ether, 1,5-diaminonaphthalene, 2,4-bis(beta-amino-t-butyl)toluene, bis(aminophenoxy)fluorene, p-xylylenediamine, 1,1′-bis[1-amino-2-methyl-4-phenyl]cyclohexane, 5-methyl-4,6-diethyl-1,3-phenylene-diamine, bis(p-b-methyl-o-aminopentyl)benzene, 2,2′,3,3′-tetrahydro-3,3,3′,3′-tetramethyl-1,1′-spirobi[1H-indene]-6,6′-diamine, 3,3′,4,4′-tetrahydro-4,4,4′,4′-tetramethyl-2,2′-spirobi[2H-1-benzopyran]-7,7′-diamine, or m-xylylenediamine. Isomers of these diamines (where isomers are possible) as well as mixtures or blends comprising at least one of the foregoing diamines can also be used. For example, the ETHACURE® diamines, such as ETHACURE® 100, which is a 80:20 weight ratio combination of 2,6-diethyl-4-methyl-1,3-phenylenediamine and 4,6-diethyl-2-methyl-1,3-phenylenediamine, respectively, and ETHACURE® 300 which is a 80:20 weight ratio combination of 2,6-bis(mercaptomethyl)-4-methyl-1,3-phenylenediamine and 4,6-bis(mercaptomethyl)-2-methyl-1,3-phenylenediamine, respectively, can also be used. In some embodiments the preferred diamino compounds are aromatic primary diamines free of benzylic hydrogens, especially m- and p-phenylenediamine, diaminodiphenyl sulfone, and mixtures thereof. In some embodiments the organic diamines may comprise functionality selected from the group consisting of ethers, alkoxys, aryloxys, sulfones, perfluoro alkyl groups, and mixtures thereof.

In some particular embodiments the polyimide structural units of formula (I) may be formally derived from at least one organic diamine and at least one aromatic dianhydride. A polyimide comprising structural units formally derived from at least one organic diamine and at least one aromatic dianhydride may be prepared by known methods including, but not limited to, the actual reaction between a dianhydride and a diamine. Illustrative examples of dianhydrides comprise cyclobutane tetracarboxylic dianhydride, cyclopentane tetracarboxylic dianhydride, cyclohexane-1,2,4,5-tetracarboxylic dianhydride, cyclohexane-1,2,5,6-tetracarboxylic dianhydride, 1,1′-bis[1-(3,4-dicarboxyphenoxy)-2-methyl-4-phenyl]cyclohexane dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, 5-(2,5-dioxotetrahydrofural)-3-methyl-3-cyclohexene-1,2-dicarboxylic dianhydride, 1,3,3a,4,5,9b-hexahydro-5-(tetrahydro-2,5-dioxo-3-furanyl)-naphtho[1,2,-c]-furan-1,3-dione, 6,6′-bis(3,4-dicarboxyphenoxy)-2,2′,3,3′-tetrahydro-3,3,3′,3′-tetramethyl-1,1′-spirobi[1H-indene]dianhydride; 7,7′-bis(3,4-dicarboxyphenoxy)-3,3′,4,4′-tetrahydro-4,4,4′,4′-tetramethyl-2,2′-spirobi[2H-1-benzopyran]dianhydride, ethylene glycol bis(trimellitic anhydride), diphenyl sulfone tetracarboxylic dianhydride, 3,3′,4,4′-diphenylsulfone tetracarboxylic dianhydride, diphenyl sulfide tetracarboxylic dianhydride, 3,3′,4,4′-diphenylsulfide tetracarboxylic dianhydride, diphenylsulfoxide tetracarboxylic dianhydride, 3,3′,4,4′-diphenylsulfoxide tetracarboxylic dianhydride, hydroquinone diphthalic anhydride, p-phenylene-bis(triphenylphthalic)dianhydride, m-phenylene-bis(triphenylphthalic)dianhydride, bis(triphenylphthalic)-4,4′-diphenylether dianhydride, bis(triphenylphthalic)-4,4′-diphenylmethane dianhydride, resorcinol diphthalic anhydride, 3,3′,4,4′-diphenylmethane tetracarboxylic dianhydride, bis(phthalic)phenylsulphineoxide dianhydride, 4,4′-bis(3,4-dicarboxyphenoxy)diphenylpropane dianhydride, 2,2-bis(3,4-dicarboxyphenyl)propane dianhydride and 2,2-bis(2,3-dicarboxyphenyl)propane dianhydride, 2,2-bis(4-(3,4-dicarboxyphenoxy)phenyl)propane dianhydride, 4,4′-bis(3,4-dicarboxyphenoxy)diphenyl ether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenyl sulfone dianhydride, 2,2-bis([4-(2,3-dicarboxyphenoxy)phenyl]propane dianhydride, 4,4′-bis(2,3-dicarboxyphenoxy)diphenyl ether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenyl sulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenoxy)benzophenone dianhydride, 4-(2,3-dicarboxyphenoxy)-4′-(3,4-dicarboxyphenoxy)diphenyl sulfone dianhydride, 1,3-bis(2,3-dicarboxyphenoxy)benzene dianhydride, 1,4-bis(2,3-dicarboxyphenoxy)benzene dianhydride, 1,3-bis(3,4-dicarboxyphenoxy)benzene dianhydride, 1,4-bis(3,4-dicarboxyphenoxy)benzene dianhydride, bisphenol-A dianhydride, 4,4′-bisphenol A dianhydride, 3,3′,4,4′-benzophenone tetracarboxylic dianhydride, 2,2′,3,3′-benzophenone tetracarboxylic dianhydride, 3,3′,4,4′-dimethyldiphenylsilane tetracarboxylic dianhydride, 3,3′,4,4′-perfluoropyridinediphthalic dianhydride, pyromellitic dianhydride, biphenyltetracarboxylic dianhydride, 3,3′,4,4′-biphenyltetracarboxylic dianhydride, 2,2′-dichloro-3,3′,4,4′-biphenyltetracarboxylic dianhydride, 2,2′-dimethyl-3,3′,4,4′-biphenyltetracarboxylic dianhydride, 2,2′-dicyano-3,3′,4,4′-biphenyltetracarboxylic dianhydride, 2,2′-dibromo-3,3′,4,4′-biphenyltetracarboxylic dianhydride, 2,2′-diiodo-3,3′,4,4′-biphenyltetracarboxylic dianhydride, 2,2′-ditrifluoromethyl-3,3′,4,4′-biphenyltetracarboxylic dianhydride, 2,2′-bis(1-methyl-4-phenyl)-3,3′,4,4′-biphenyltetracarboxylic dianhydride, 2,2′-bis(1-trifluoromethyl-2-phenyl)-3,3′,4,4′-biphenyltetracarboxylic dianhydride, 2,2′-bis(1-trifluoromethyl-3-phenyl)-3,3′,4,4′-biphenyltetracarboxylic dianhydride, 2,2′-bis(1-trifluoromethyl-4-phenyl)-3,3′,4,4′-biphenyltetracarboxylic dianhydride, 2,2′-bis(1-phenyl-4-phenyl)-3,3′,4,4′-biphenyltetracarboxylic dianhydride, 2,2′-bis(1,3-trifluoromethyl-4-phenyl)-3,3′,4,4′-biphenyltetracarboxylic dianhydride, (3,3′,4,4′-diphenyl)phenylphosphine tetracarboxylic dianhydride, (3,3′,4,4′-diphenyl)phenylphosphineoxide tetracarboxylic dianhydride, 2,2-bis(3,4-dicarboxyphenyl)hexafluoropropane dianhydride, 2,2-bis[4-(3,4-dicarboxyphenoxy)phenyl]hexafluoropropane dianhydride, naphthalic dianhydride, 2,3,6,7-naphthalic dianhydride, 3,3′,4,4′-biphenylsulphonictetracarboxylic dianhydride, 3,4′-oxydiphthalic anhydride, 4,4′-oxydiphthalic anhydride, or 3,3′-oxydiphthalic anhydride. Isomers of these dianhydrides (where isomers are possible) as well as mixtures or blends comprising at least one of the foregoing dianhydrides can also be used. Most preferred dianhydrides are bisphenol-A dianhydride, benzophenone tetracarboxylic dianhydride, pyromellitic dianhydride, biphenyl tetracarboxylic dianhydride, or oxydiphthalic anhydride. Other illustrative examples of some specific aromatic dianhydrides are disclosed, for example, in U.S. Pat. Nos. 3,972,902 and 4,455,410. Additional illustrative examples of some specific aromatic dianhydrides and aromatic diamines are disclosed, for example, in U.S. Pat. Nos. 5,298,331 and 6,476,177.

In particular embodiments suitable polyimides comprise thermoplastic polyimides such as, but not limited to, AURUM® polyimide prepared by reacting 4,4′-bis(3-aminophenoxy)biphenyl with pyromellitic dianhydride and available from Mitsui Chemicals America; NASA Langley Research Center thermoplastic polyimide (LARC-TPI); NASA Langley Research Center crystallizable polyimide (LARC-CPI); UPILEX® polyimide available from Ube Industries; or APICAL® polyimide available from Kaneka Corporation, Japan. Some other illustrative examples of suitable thermoplastic polyimides may be found in U.S. Pat. Nos. 4,847,311, 6,103,806, and 6,458,912.

Exemplary classes of polyimide resins also comprise poly(amideimide) resins and polyetherimide resins, particularly those polyetherimide resins known in the art which are melt processable. Particular embodiments of polyimide resins are polyetherimides or copolymers comprising both polyimide and polyetherimide structural units.

In some embodiments polyetherimide resins comprise more than 1, typically about 10 to about 1000, and more specifically about 10 to about 500 structural units, of the formula (VIII):

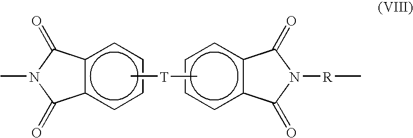

wherein R is as previously defined for formula (I) and T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals as defined above.

Certain polyetherimides herein comprise structural units formally derived from combination of one or more dianhydrides with an organic diamine of the formula (IX):

H₂N—R—NH₂ (IX)

wherein R is defined as described above in formula (I). In some embodiments melt processable polyimides may be made by reaction of more or less equal molar amounts of dianhydride or chemical equivalent thereof with a diamine containing a flexible linkage. In some embodiments the amounts of dianhydride and diamine in the reaction differ by less than 5 mole %. In a particular embodiment the polyetherimide comprises structural units according to formula (VIII) wherein each R is independently p-phenylene or m-phenylene or a mixture comprising at least one of the foregoing, and T is a divalent radical of the formula (X)

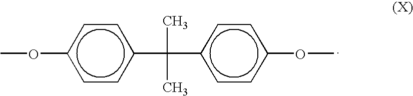

In one embodiment the polyetherimide may be a copolymer, which, in addition to the etherimide units described above, further contains polyimide structural units of the formula (XI):

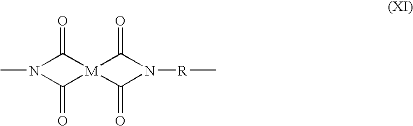

wherein R is as previously defined for formula (I) and M includes, but is not limited to, radicals of formula (II), given hereinabove.

In some embodiments polyetherimides have at least 50 mole % imide linkages derived from an aromatic bis(ether anhydride) that is an oxydiphthalic anhydride or the reactive equivalent thereof. Oxydiphthalic anhydrides may be represented by the formula (XII):

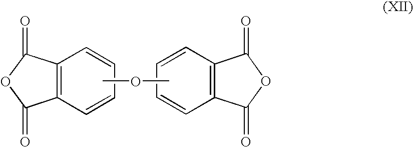

and derivatives thereof. Illustrative oxydiphthalic anhydrides comprise 4,4′-oxybisphthalic anhydride, 3,4′-oxybisphthalic anhydride, 3,3′-oxybisphthalic anhydride, and mixtures thereof. In a particular embodiment a polyetherimide comprises from about 60 mole % to about 100 mole % oxydiphthalic anhydride derived imide linkages, in an alternative embodiment from about 70 mole % to about 99 mole % oxydiphthalic anhydride derived imide linkages, and in yet another embodiment from about 80 mole % to about 97 mole % oxydiphthalic anhydride derived imide linkages, and ranges there between, based on the moles of dianhydride derived structural units present in the polyetherimide.

Copolymers of polyetherimides which include structural units derived from imidization reactions of mixtures of the oxydiphthalic anhydrides listed above having two, three, or more different dianhydrides, and a more or less equal molar amount of an organic diamine with a flexible linkage, are also within the scope of the invention. In addition, copolymers that have at least about 50 mole % imide linkages derived from oxydiphthalic anhydrides defined above, which includes derivatives thereof, and up to about 50 mole % of alternative dianhydrides distinct from oxydiphthalic anhydride are also contemplated. That is, in some instances copolymers, in addition to having at least about 50 mole % linkages derived from oxydiphthalic anhydride, will also include imide linkages derived from aromatic dianhydrides different than oxydiphthalic anhydrides such as, for example, bisphenol-A dianhydride (BPADA), disulfone dianhydride, benzophenone dianhydride, bis(carbophenoxy phenyl)hexafluoropropane dianhydride, bisphenol dianhydride, pyromellitic dianhydride (PMDA), biphenyl dianhydride, sulfur dianhydride, sulfo dianhydride or mixtures thereof. In some embodiments polyetherimides comprising structural units derived from an oxydiphthalic anhydride have a glass transition temperature (Tg) of about 270° C. or higher, and melt viscosity in a range of from about 200 Pascal-seconds to about 10,000 Pascal-seconds at 425° C. as measured by ASTM method D3835.

In another embodiment polyetherimides comprise structural units derived from imidization reactions of at least one oxydiphthalic dianhydride and a more or less equal molar amount of at least one organic diamine as described above where the organic diamine includes an aryl diamine containing a flexible linkage. For example, a homopolymer which is the reaction product of 100 mole % (based on total anhydride) oxydiphthalic anhydride and 100 mole % aryl diamine (based on total diamine) is within the scope of the invention. In addition, copolymers containing 100 mole % imide linkages derived from oxydiphthalic anhydride and two or more aryl diamines, or copolymers described above having imide linkages derived from two or more dianhydrides, including at least about 50 mole % oxydiphthalic anhydride (based on total anhydride), and at least one aryl diamine are also contemplated.

In another embodiment at least about 50 mole % of the imide linkages (based on total imide linkages) of the polyetherimide are sulfone linkages. In such case a portion of at least one of the aromatic dianhydride reactants or diamine reactants which forms the polyetherimide composition includes a sulfone linkage. In one embodiment the polyetherimide includes structural units that are derived from an aryl diamino sulfone of the formula (XIII):

H₂N—Ar—SO₂—Ar—NH₂ (XIII)

wherein Ar can be an aryl group containing a single or multiple rings. Several aryl rings may be linked together, for example through ether linkages, sulfone linkages or more than one sulfone linkage. The aryl rings may also be fused.

In another embodiment the polyetherimide comprises at least one aryl ether linkage derived from oxydiphthalic anhydride as defined above and at least one aryl sulfone linkage. The diamine employed in the synthesis of the polyetherimide composition can comprise at least about 50 mole % of aryl diamino sulfone, in an alternative embodiment from about 50 mole % to about 100 mole % aryl diamino sulfone, in another alternative embodiment from about 70 mole % to about 100 mole % aryl diamino sulfone, and in yet another embodiment from about 85 mole % to about 100 mole % aryl diamino sulfone, and ranges therebetween, based on the moles of aryl diamine used to form the polyetherimide. In one example at least 50 mole % of the repeat units of the polyetherimide contain one aryl ether linkage and one aryl diamino sulfone linkage. In a particular embodiment a suitable polyetherimide comprises structural units derived from BPADA and 4,4′-diaminodiphenylsulfone. In another particular embodiment a suitable polyetherimide comprises structural units derived from oxydiphthalic anhydride and 4,4′-diaminodiphenylsulfone.

In alternative embodiments, the amine groups of the aryl diamino sulfone can be meta or para to the sulfone linkage, for example, as in formula (XIV):

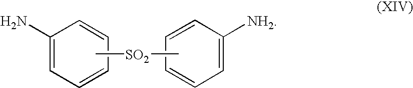

Such aromatic diamines include, but are not limited to, diamino diphenyl sulfone, particularly 4,4′-diaminodiphenylsulfone (DDS), and bis(aminophenoxy phenyl)sulfones (BAPS). The oxydiphthalic anhydrides described above may be used to form polyimide linkages by reaction with an aryl diamino sulfone to produce polyetherimide sulfones.

In another embodiment a polyetherimide copolymer comprises structural units derived from aryl diamino sulfone and from about 50-85 mole % oxydiphthalic anhydride and from about 15-50 mole % of bisphenol-A dianhydride or “BPADA”, based on the collective moles of dianhydride derived units present. Oxydiphthalic anhydride/bisphenol-A dianhydride (ODPA/BPADA) copolymers comprising additional aromatic dianhydrides and two or more aryl diamino sulfones are also contemplated. In one embodiment copolymers may be derived from two or more dianhydrides where at least about 50 mole % imide linkages are derived from oxydiphthalic anhydride and two or more diamines, provided that at least 50 mole % of the diamines have flexible linkages and the polyimide made from them is melt processable with a Tg of at least about 270° C. Copolymers may be made reacting a mixture of aryl diamines with oxydiphthalic anhydride. For instance a mixture of 4,4′-diamino diphenyl sulfone and 3,3′-diamino diphenyl sulfone may be employed. In addition mixtures of several dianhydrides and several diamines may be used in so far that at least 50 mole % of the imide linkages in the polymer are derived from oxydiphthalic anhydride and said imide linkages have at least one other flexible linkage. Examples of a second flexible linkage include, but are not limited to, ethers, sulfones and sulfides.

Illustrative polyetherimides and methods to make them are disclosed, for example, in U.S. Pat. Nos. 3,787,364, 3,803,085, 3,847,867, 3,847,869, 3,850,885, 3,852,242, 3,855,178, 3,905,942, 3,917,643, 3,983,093, 4,443,591, 4,689,391, 4,835,249, 4,965,337, 5,229,482, 5,830,974, and 6,849,706, and in published U.S. Patent Application Nos. 20040249117, 20050049390 and 20050070684.

In some embodiments of the invention suitable polyimides have a Tg of greater than about 200° C., preferably greater than about 210° C., and more preferably greater than about 220° C. In other embodiments suitable polyimides comprise those with structural units derived from 3,4-diaminodiphenylether and 4,4-oxydiphthalic anhydride, those with structural units derived from 4,4′-bis(3-aminophenoxy)biphenyl and pyromellitic dianhydride, those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, or those with structural units derived from diaminodiphenylsulfone and bisphenol-A dianhydride.

Blends comprising a first polyimide with at least one other polyimide or other type of thermoplastic resin may also be employed in embodiments of the invention. Such blends are typically either miscible, partially miscible, or compatibilized. Miscible or semi-miscible blends and suitable compatibilization methods are well known in the art. Blends comprising at least two polyimides may be employed. Non-limiting examples of such polyimide blends comprise polyimide-polyimide blends, polyimide-polyetherimide blends, polyimide-polyamideimide blends, polyetherimide-polyetherimide blends, polyetherimide-polyamideimide blends, or the like. In some particular embodiments blends comprising at least two polyimides comprise combinations of polyimides selected from the group consisting of those with structural units derived from diaminodiphenylsulfone and 4,4-oxydiphthalic anhydride, those with structural units derived from diaminodiphenylsulfone and bisphenol-A dianhydride, those with structural units derived from 4,4′-bis(3-aminophenoxy)biphenyl and pyromellitic dianhydride, those with structural units derived from bisphenol-A dianhydride and meta-phenylenediamine, those with structural units derived from p-phenylenediamine and bisphenol-A dianhydride, and those with structural units derived from 3,4-diaminodiphenylether and 4,4-oxydiphthalic anhydride. In other particular embodiments blends comprising at least two polyimides comprise a blend of a polyimide with structural units derived from diaminodiphenylsulfone and 4,4-oxydiphthalic anhydride, and a polyimide with structural units derived from diaminodiphenylsulfone and bisphenol-A dianhydride, a blend of a polyimide with structural units derived from 4,4′-bis(3-aminophenoxy)biphenyl and pyromellitic dianhydride, and either a polyimide with structural units derived from bisphenol-A dianhydride and meta-phenylenediamine, or a polyimide with structural units derived from p-phenylenediamine and bisphenol-A dianhydride, or a blend of a polyimide with structural units derived from 3,4-diaminodiphenylether and 4,4-oxydiphthalic anhydride and either a polyimide with structural units derived from bisphenol-A dianhydride and meta-phenylenediamine, or a polyimide with structural units derived from p-phenylenediamine and bisphenol-A dianhydride. In still other embodiments suitable blends include those comprising a polyimide and at least one thermoplastic resin selected from the group consisting of a polysulfone, a polyarylsulfone, a polyphenylsulfone, a polyethersulfone, a polyarylene ether, a polyphenylene ether such as poly(2,6-dimethyl-1,4-phenylene ether), a polyphenylene sulfide, a polyetheretherketone (PEEK), a polyetherketone, a polybenzimidazole, and like materials.

In some embodiments polyimides may optionally comprise one or more conventional additives. Illustrative additives comprise colorants, pigments, dyes, carbon black, titanium dioxide, anti-oxidants, flame retardants, ceramic filler, thermally conductive filler, or additives to adjust the dielectric constant of the resin, such as, but not limited to, one or more dielectric adjustment additives selected from metal oxides, illustrative examples of which include aluminum oxide.

In some embodiments the invention is directed to a biaxially oriented monolithic film. In particular embodiments a monolithic film is one comprising a polyimide comprising structural units derived from 3,4-diaminodiphenylether and 4,4-oxydiphthalic anhydride, optionally combined with at least one other polyimide. In other particular embodiments a monolithic film is one comprising a polyimide comprising structural units derived from 3,4-diaminodiphenylether and 4,4-oxydiphthalic anhydride present in a range of between about 60 wt. % and about 100 wt. % and at least one other polyimide present in a range of between about 40 wt. % and 0 wt. % and selected from the group consisting of those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, and those with structural units derived from diaminodiphenylsulfone and bisphenol-A dianhydride.

In some embodiments the invention is directed to a biaxially oriented multilayer film comprising the structure A-B or A-B-A, wherein A and B represent separate layers, and wherein at least one of A or B represents a layer comprising a polyimide and the other of A and B represents a layer comprising a different thermoplastic resin which optionally may be a different polyimide. In some embodiments the layer A may serve to improve the adhesion of the multilayer film to a substrate such as, but not limited to, a conductive layer. Furthermore, in some embodiments the layer A in the biaxially oriented multilayer film comprises an amorphous resin. Optionally, the amorphous resin may further comprise at least one crystallizable resin provided that the layer A has a lower degree of crystallinity in the biaxially oriented multilayer film than the layer B. When present, the amount of said crystallizable resin is in a range of between about 0.5 wt. % and about 40 wt. % based on the total weight of the layer A. Alternatively, the layer A may predominantly comprise a crystallizable resin or a mixture comprising at least two crystallizable resins provided that the layer A has a lower melting temperature in the biaxially oriented multilayer film than the layer B. In some embodiments the layer A has a lower Tg than the layer B. In other embodiments the layer A has a lower melting temperature than the layer B. The layer B in the biaxially oriented multilayer film is typically derived from at least one crystallizable resin. Optionally, the crystallizable resin of layer B may further comprise at least one amorphous resin. When present, the amount of said amorphous resin in layer B is in a range of between about 0.5 wt. % and about 40 wt. % based on the total weight of the layer B. In some embodiments of the invention the relative thicknesses of layer A and layer B in a biaxially oriented multilayer film are typically in a ratio in a range of between about 1:5 A:B and about 1:100 A:B. In some embodiments of the invention crystallizable and amorphous polyimides comprise those with structural units formally derived from (i) a dianhydride selected from the group consisting of bisphenol-A dianhydride, oxydiphthalic anhydride, benzophenone tetracarboxylic dianhydride, biphenyl tetracarboxylic dianhydride, pyromellitic dianhydride, and mixtures thereof and (ii) a diamine selected from the group consisting of meta-phenylenediamine, para-phenylenediamine, oxydianiline, diaminodiphenylsulfone, 1,3-bis(3-aminophenoxy)benzene, 1,3-bis(4-aminophenoxy)benzene, 4,4′-bis(3-aminophenoxy)biphenyl, 4,4′-bis(4-aminophenoxy)biphenyl, bis(aminophenoxy)benzophenone, and mixtures thereof. Those skilled in the art will recognize that crystallizable or amorphous polyimide resin may be obtained depending upon such factors as the specific identity and amounts of dianhydrides and diamines employed in the polyimide synthesis, among other factors.

In other embodiments crystallizable polyimides comprise those with structural units derived from 3,4-diaminodiphenylether and 4,4-oxydiphthalic anhydride or those with structural units derived from 4,4′-bis(3-aminophenoxy)biphenyl and pyromellitic dianhydride. Blends comprising at least two crystallizable polyimides may be employed as any crystallizable resin component. In still other embodiments amorphous polyimides comprise those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, or those with structural units derived from diaminodiphenylsulfone and bisphenol-A dianhydride. Blends comprising at least two amorphous polyimides may be employed as any amorphous resin component.

Polyimide-comprising films may be prepared using known methods, illustrative examples of which include film extrusion. Multilayer films may be assembled using known methods such as by thermal lamination under pressure, a roll-to-roll process, a coextrusion process, or like methods. When more than two layers are present in the multilayer film, the film may be prepared by assembly of at least two layers followed by further assembly with one or more remaining layers in one or more subsequent steps, or by assembling all the layers at once. A tie-layer may optionally be present between any two layers of a multilayer film. In some particular embodiments multilayer films are assembled using coextrusion. Coextrusion may optionally be accomplished using a multi-manifold die or like equipment. In other particular embodiments at least one polyimide-comprising layer of a multilayer resin film may be deposited by at least one step of solution casting of a polyimide precursor solution onto a separate monolithic polyimide film followed by at least one step comprising biaxially stretching. An illustrative polyimide precursor solution comprises a solution of a polyamic acid.

Biaxial orientation of multilayer or monolithic films may be performed using known methods. Typically, the film to be biaxially oriented is stretched in the machine direction and in the transverse direction. The machine direction may be referred to as the longitudinal direction and the transverse direction may be referred to as the lateral direction. Examples of methods for stretching films include a simultaneous biaxial stretching method in which a longitudinal stretching and a lateral stretching are performed simultaneously, a sequential biaxial stretching method in which a longitudinal stretching and a lateral stretching are performed sequentially and, in addition, a so-called longitudinal re-stretching method in which a film sequentially stretched in two directions of longitudinal and lateral directions is stretched again in the longitudinal direction to enhance the strength in the longitudinal direction; a longitudinal re-stretching and lateral re-stretching method in which after the above-described longitudinal re-stretching is performed, the film is stretched again in the lateral direction to further enhance the strength in the lateral direction as well; and a multi-step longitudinal stretching method in which a film is stretched in a longitudinal direction in at least two steps and, subsequently, the film is stretched in a lateral direction. In some particular embodiments the film, after biaxial stretching, may be subjected to relaxation under tension followed by annealing. In other particular embodiments the film may be subjected to process steps comprising annealing in any step after the stretching in one direction is performed. Annealing is typically performed at a temperature higher than or equal to the highest measured glass transition temperature (Tg) of resin in the film. In particular embodiments annealing is performed at a temperature in a range of between about 25° C. and about 75° C. higher, and preferably at a temperature in a range of between about 35° C. and about 55° C. higher than the highest measured Tg of resin in the film. The stretching temperature is in some embodiments in a range of between about 5° C. and about 10° C. below the annealing temperature. In various embodiments the stretching ratio is within the range of ratios of 2.0 to 10 and preferably within the range of 2.5 to 5.

Laminates comprising (i) a biaxially oriented multilayer resin film or a biaxially oriented monolithic resin film, (ii) a conductive layer such as, but not limited to, a metal foil, and (iii) optionally an adhesive layer interposed between the resin film and conductive layer constitute another embodiment of the invention. In some embodiments suitable metal foils comprise a copper or copper-based alloy. In other particular embodiments suitable metal foils comprise copper, zinc, brass, chrome, nickel, aluminum, stainless steel, iron, gold, silver, titanium or combinations or alloys thereof. In preferred embodiments the metal foil comprises copper. Alternatively, roll-annealed, electro-deposited, or wrought metal foils may be used. In other particular embodiments metal foils comprise an electrically conductive material.

Conductive layers in embodiments of the invention typically have a thickness in a range of from about 2 micrometers to about 200 micrometers, preferably in a range of between from about 5 micrometers to about 50 micrometers, and more preferably in a range of between from about 5 micrometers to about 40 micrometers. In other embodiments a metal foil formed on a supporting substrate (carrier), that is, a so-called carrier-borne metal foil, may be used to form the conductive layer. A typical carrier-borne metal foil is a copper foil laminated on an aluminum carrier with a parting layer interposed there between, which is available commercially. The copper foil may optionally be patterned beforehand by etching with, for instance, an aqueous solution of iron chloride or an aqueous solution of ammonium persulfate. The aluminum carrier may be removed by etching with hydrochloric acid or the like. In some embodiments monolithic or multilayer resin film, or conductive layer, or both may optionally be pretreated before use in assembly of the laminates. Illustrative treatment methods comprise one or both of (i) chemical treatment such as with a silane, a passivation agent, a cleaning agent, an anti-oxidant, or an etching agent, or capping with a tie-coat of at least one other metal, or (ii) physical treatment such as by flame treatment, plasma or corona discharge, laser etching, mechanical cleaning, mechanical roughening, or heat treating.

The optional adhesive layer may comprise any adhesive material effective to enhance adhesion between resin film and conductive layer. Suitable adhesive materials are known in the art and may be selected and applied without undue experimentation. In some embodiments an adhesive material may comprise an epoxy resin, a polyester/epoxy resin, an acrylic resin, a silicone paste, or a polyurethane resin. The adhesive material may be applied by any known method including, but not limited to, solution application, dip coating, extrusion coating, film application, or like method. In various embodiments the optional adhesive layer may be applied onto the conductive layer surface and then assembled into a laminate with resin film, or coated onto the resin film first and then assembled into a laminate with the conductive layer.

Laminates in embodiments of the invention may be assembled using known methods comprising one or more steps, such as by employing one or more thermal lamination steps. In a particular embodiment a laminate may be made by thermal lamination under pressure without employing an adhesive layer. In one particular embodiment at least one biaxially oriented resin film and at least one layer of metal foil are thermally laminated under pressure to form a laminate. In still other particular embodiments a biaxially oriented resin film and a layer of metal foil are laminated by a roll-to-roll or roll calendaring method. In embodiments wherein the laminate comprises a multilayer biaxially oriented film comprising the structure A-B or A-B-A, wherein A and B represent separate layers, the laminate is typically assembled with the metal foil in contact with that side of the biaxially oriented multilayer film which predominately comprises amorphous resin. In another embodiment the metal foil is in contact with at least one side A of the biaxially oriented multilayer film. In yet another embodiment the metal foil is in contact with one side A of the biaxially oriented multilayer film. In alternative embodiments a laminate may be made by depositing metal onto that side of the biaxially oriented multilayer film which predominately comprises amorphous resin using a vacuum deposition method or a sputtering method or a solution method or an electrolytic method, such as electrodeposition, or like method. Such latter methods are particularly useful for providing laminates with very thin layers of metal. Multilayer laminates comprising additional layers may also be made in one step or in two or more consecutive processing steps. In some embodiments 7 layers or fewer may be present in the laminate and in other embodiments 16 layers or fewer.

Monolithic and multilayer polyimide-comprising films in various embodiments of the invention have a coefficient of thermal expansion (CTE) of less than about 35 ppm/° C., and preferably less than about 30 ppm/° C. In other embodiments monolithic and multilayer polyimide-comprising films have a CTE in the transverse direction that differs from the CTE in the machine direction by less than about 15 ppm/° C., preferably less than about 10 ppm/° C., and more preferably less than about 5 ppm/° C.

In other embodiments of the invention directed to laminates of monolithic or multilayer polyimide-comprising film with a metal foil, the monolithic or multilayer polyimide-comprising film has a CTE that differs from the CTE of the metal foil by less than about 30 ppm/° C., preferably less than about 15 ppm/° C., and more preferably less than about 10 ppm/° C. In particular embodiments the monolithic or multilayer polyimide-comprising film has a CTE that differs from the CTE of the metal foil by a value that is in a range of between about 0 ppm/° C. and about 30 ppm/° C., preferably in a range of between about 0 ppm/° C. and about 15 ppm/° C. and more preferably in a range of between about 0 ppm/° C. and about 10 ppm/° C.

Laminates in embodiments of the invention may be flexible or semi-flexible (for example, for use in rigid-flex applications). The laminates typically have an overall thickness of less than about 4000 micrometers and preferably less than about 1000 micrometers, wherein overall thickness refers to a laminate comprising at least one layer of metal foil and at least one layer of biaxially oriented film, which film may be monolithic or multilayer. Laminates in some particular embodiments of the present invention have an overall thickness of less than about 500 micrometers and preferably less than about 300 micrometers. Laminates in still other particular embodiments of the present invention are flexible and have an overall thickness of less than about 100 micrometers. In other particular embodiments laminates have an overall thickness of less than or equal to about 98 micrometers, preferably of less than about 95 micrometers, more preferably of less than about 80 micrometers, and still more preferably of less than about 50 micrometers. In still other particular embodiments laminates have an overall thickness of less than about 25 micrometers and preferably less than about 15 micrometers. In still other particular embodiments laminates have an overall thickness in a range of between about 10 micrometers and about 98 micrometers, preferably in a range of between about 12 micrometers and about 95 micrometers, and more preferably in a range of between about 15 micrometers and about 50 micrometers. There is no particular limitation on the thickness of the biaxially oriented film as long as a desired overall thickness of the laminate is achieved. In some embodiments the thickness of the biaxially oriented film is in a range of between about 5 micrometers and about 750 micrometers, preferably in a range of between from about 10 micrometers to about 150 micrometers, and more preferably in a range of between from about 10 micrometers to about 100 micrometers.

Articles comprising a biaxially oriented film described in embodiments of the invention are another aspect of the invention. Such articles include, but are not limited to, photographic film and magnetic recording medium. Such articles also include, but are not limited to, those which typically comprise laminates which comprise a biaxially oriented film, a conductive layer such as copper, and optionally an adhesive layer interposed between the film and conductive layers. Other articles include those comprising flex circuits as used in medical or aerospace industries. Still other articles include antennae and like articles. In still other embodiments articles comprising a biaxially oriented film of the invention comprise multilayer circuit boards for high frequency applications. In other embodiments such articles include, but are not limited to, those comprising FPC, illustrative examples of which comprise cameras, audio and video equipment, and office automation equipment. In other embodiments electrical parts may be mounted on FPCs comprising a biaxially oriented film of the invention, similar to conventional printed circuit boards.

The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples Polyimide-1 (“P-1”) had a glass transition temperature (Tg) of 230° C. and comprised structural units derived from 3,4-diaminodiphenylether and 4,4-oxydiphthalic anhydride, Polyimide-2 (“P-2”) had a glass transition temperature (Tg) of 272° C. and comprised structural units derived from 4,4-diaminodiphenylether and 4,4-oxydiphthalic anhydride, Polyimide-3 comprised structural units derived from 4,4′-bis(3-aminophenoxy)biphenyl and pyromellitic dianhydride, Polyimide-4 had a Tg of about 217° C. and comprised structural units derived from bisphenol-A dianhydride and meta-phenylenediamine available as ULTEM® 1000 from the General Electric Company, Polyimide-5 had a Tg of 225° C. and comprised structural units derived from p-phenylenediamine and bisphenol-A dianhydride, and Polyimide-6 (“PI-5”) had a Tg of 267° C. and comprised structural units derived from diaminodiphenylsulfone and bisphenol-A dianhydride. Biaxial film stretching was conducted using a laboratory biaxial stretcher made by Toyo Seiki. Uniaxial film stretching was conducted on an Instron machine equipped with internal heating chamber. Heats of fusion data were determined by differential scanning calorimetry (DSC) and are given in Joules per gram. Copper foil was 0.035 mm in thickness obtained from Gould Electronics, Chandler, Ariz. The copper foil adhesion test was performed using the test method IPC-TM-650.2.4.9. Regarding the radius of curvature data, a plus sign means that the laminate curved toward the resin film side; a minus sign means that the laminate curved toward the copper foil side. The abbreviations “Ex.” and “C.Ex.” “example” and “comparative example”, respectively. The abbreviations “n/a” and “n/m” mean “not applicable” and “not measured”, respectively. The abbreviations MD and TD mean “machine direction” and “transverse direction”, respectively.

The solder float test was conducted according to test method IPC-TM-650-2.4.13. Test specimens were dried in an oven at 135° C. for one hour, and then attached to the solder float bath at 260° C. for 10 seconds. After removing from the solder bath, the specimen was thoroughly cleaned and inspected for blistering, shrinkage, distortion and/or melting.

CTE measurements were performed by thermo-mechanical analysis (TMA) after biaxial stretching, relaxation and annealing of test specimens. Test specimen dimensions were 24 mm in length by 5 mm in width. Test specimens were subjected to a first heat from 25° C. to 210° C. at 5° C./min heating rate and CTE values were determined under a force of 0.05 Newtons from the slope of length change over the temperature range from 25° C. to 200° C. Since the annealing process relieves stress and lowers shrinkage in the film, the CTE measurement was made during the first heat cycle.

### EXAMPLE 1 AND COMPARATIVE EXAMPLES 1-3

Polyimide-1 and Polyimide-2 resins were separately extruded into 500 micron film by melt extrusion calendering. In Example 1 the Polyimide-1 film was stretched in simultaneous biaxial mode to 3.5×3.5 at 200 millimeters per minute (mm/min.) at 280° C. Following stretching, the film was subjected to heat-set under conditions of 5% relaxation under tension and annealing for 15 minutes at 280° C. Both Polyimide-1 and Polyimide-2 films were uniaxially stretched to 2.4 at 12.7 centimeters per minute at 260° C. Comparative example 3 was not stretched. Characterization data are shown in Table 1.

TABLE 1

| | Film | | CTE | CTE | Heat of | |
|---|---|---|---|---|---|---|
| Ex. or | thickness | Film Process | MD | TD | fusion | 260° C. Solder |
| C. Ex. | microns | method | ppm/° C. | ppm/° C. | J/g | Float |
| Ex. 1 | 20 | biaxially | 15.1 | 16 | 18.7 | No wrinkles at |
| P-1 | | stretched | | | | center; only |
| | | | | | | slight curling at |
| | | | | | | edge |
| C. Ex. 1 | 25 | uniaxially | n/m | n/m | 5.77 | n/m |
| P-1 | | stretched | | | | |
| C. Ex. 2 | 25 | uniaxially | n/m | n/m | 0 | n/m |
| P-2 | | stretched | | | | |
| C. Ex. 3 | 25 | none | 50 | 50 | 0 | Severe wrinkle |
| P-1 | | | | | | and distortion at |
| | | | | | | center and edge |

The data in Table 1 show that biaxial stretching reduced CTE from 50 to about 15 and that balanced CTE in MD and TD was obtained in Example 1. In addition, stretching followed by relaxation and annealing enhanced crystallinity and improved solder float performance in comparison to Comparative Example 3. Uniaxially stretched Polyimide-1 film in Comparative Example 1 also showed some enhancement in crystallinity. Surprisingly, uniaxially stretched Polyimide-2 in Comparative Example 2 did not show crystallization compared to Comparative Example 1. If Polyimide-2 is biaxially stretched, it shows no enhancement in crystallinity.

The biaxially stretched film from Example 1 and the unstretched film from Comparative Example 3 were thermally laminated to copper foil using a hot press. After cooling to room temperature, the laminate made from biaxially stretched film of Example 1 was much flatter than the laminate made from unstretched film of Comparative Example 3. This comparison shows the importance of balanced low CTE produced by biaxial stretching of the film, making it suitable for use in conjunction with metal foil in flexible printed circuits applications.

### EXAMPLE 2 AND COMPARATIVE EXAMPLES 4-5

The effect of biaxial stretch temperature on maximum stretch ratio and uniformity of stretch behavior for Polyimide-1 film is illustrated in Table 2. All the films were stretched in simultaneous mode at a rate of 100 mm/min. The maximum stretch ratio given in the table is the stretch ratio at which the test specimen broke. The data in Table 2 indicate that higher stretching temperatures allow greater stretch ratio and provide more uniform stretch behavior for melt extruded Polyimide-1 films.

TABLE 2

| Ex. or | Stretch temp. | Maximum | |
|---|---|---|---|
| C. Ex. | ° C. | stretch ratio | Comments |
| Ex. 2 | 280 | 3.75 | Uniform stretch without |
| | | | stress whitening |
| C. Ex. 4 | 250 | 2.2 | Non-uniform stretch with |
| | | | stress whitening |
| C. Ex. 5 | 240 | 2 | Non-uniform stretch with |
| | | | stress whitening |

### EXAMPLE 3 AND COMPARATIVE EXAMPLE 6

To investigate the effect of stretch ratio on uniformity of stretch behavior, 150 micron thick samples of Polyimide-1 film were biaxially stretched in simultaneous mode at 280° C. to the stretch ratios of 2×2 and 3×3. The sample stretched to 3×3 stretch ratio provided a more uniform stretched sample than the comparative sample stretched to the stretch ratio of 2×2. This observation indicates that a higher stretch ratio at appropriate temperature results in more uniform stretch behavior for Polyimide-1.

### EXAMPLES 4-12

Polyimide-1 extruded films of 150 micron thickness were biaxially stretched. The stretch ratio was 3×3 and stretching conditions were varied. The results are shown in Table 3. The data of Table 3 show that a balanced CTE is obtainable using either simultaneous and sequential biaxial stretching modes.

TABLE 3

| | | | | CTE | CTE |
|---|---|---|---|---|---|
| | Stretch temp. | | Stretch Rate | MD | TD |
| Ex. | ° C. | Mode | mm/min | ppm/° C. | ppm/° C. |
| 4 | 285 | sequential | 100 | 11 | 37.2 |
| 5 | 275 | sequential | 1000 | 0 | 39.3 |
| 6 | 275 | simultaneous | 100 | 10.9 | 8.9 |
| 7 | 285 | simultaneous | 1000 | 12.5 | 14.9 |
| 8 | 280 | simultaneous | 550 | 17.8 | 9.1 |
| 9 | 275 | simultaneous | 100 | 13.3 | 14.5 |
| 10 | 285 | sequential | 100 | 14.1 | 35.6 |
| 11 | 285 | simultaneous | 1000 | 12.7 | 16.7 |
| 12 | 280 | sequential | 550 | 18.9 | 12.6 |

### EXAMPLES 13-20 AND COMPARATIVE EXAMPLES 7-8

Polyimide resins were extruded into film. In the comparative examples neat polyimide resins were extruded into film but not further processed by stretching. In examples of the invention polyimide-comprising films were stretched in simultaneous biaxial stretching mode, then heat-set under conditions of 5% relaxation and 5 minutes annealing time. In some examples polyimide-comprising films of different types were laminated together before stretching. Annealing temperatures are given in Table 4.

TABLE 4

| | | | Biaxial Stretching Conditions | | | | Properties | | |
|---|---|---|---|---|---|---|---|---|---|
| | | | Stretch | Stretch | | Anneal | | CTE | CTE |
| Ex. or | | | temp. | Rate | | temp. | Thickness | MD | TD |
| C. Ex. # | Resin | Treatment | ° C. | mm/min | Ratio | ° C. | microns | ppm/° C. | ppm/° C. |
| C. Ex. 7 | Polyimide-1 | Extruded | n/a | n/a | n/a | n/a | 150 | 50 | 50 |
| Ex. 13 | 63.5 μm Polyimide-1 | Extruded, then | 270 | 200 | 3.5 × 3.5 | 280 | 20 | 18 | 23 |
| | | biaxially stretched | | | | | | | |
| Ex. 14 | 12.7 μm Polyimide-4 and 508 μm | Extruded, laminated, | 270 | 200 | 3 × 3 | 280 | 17.2 | n/m | n/m |
| | Polyimide-1 laminated at 250° C. by | then biaxially stretched | | | | | | | |
| | hot press | | | | | | | | |
| Ex. 15 | 25.4 μm Polyimide-4 and 508 μm | Extruded, laminated, | 270 | 200 | 3 × 3 | 280 | 22.9 | 25 | 27 |
| | Polyimide-1 laminated at 250° C. by | then biaxially stretched | | | | | | | |
| | hot press | | | | | | | | |
| Ex. 16 | 50.8 μm Polyimide-4 and 508 μm | Extruded, laminated, | 270 | 200 | 3 × 3 | 280 | 18.3 | n/m | n/m |
| | Polyimide-1 laminated at 250° C. by | then biaxially stretched | | | | | | | |
| | hot press | | | | | | | | |
| Ex. 17 | 101 μm Polyimide-4 and 508 μm | Extruded, laminated, | 270 | 200 | 3 × 3 | 280 | 20.3 | n/m | n/m |
| | Polyimide-1 laminated at 250° C. by | then biaxially stretched | | | | | | | |
| | hot press | | | | | | | | |
| C. Ex. 8 | Polyimide-3 | Extruded | n/a | n/a | n/a | n/a | 25.4 | 50 | 50 |
| Ex. 18 | 203 μm Polyimide-3 | Extruded, then | 290 | 100 | 3 × 3 | 295 | 21.3 | 10 | 15 |
| | | biaxially stretched | | | | | | | |
| Ex. 19 | 25.4 μm Polyimide-4/203 μm | Extruded, laminated, | 290 | 100 | 3 × 3 | 295 | 23.4 | 14 | 20 |
| | Polyimide-3 laminated at 250° C. by | then biaxially stretched | | | | | | | |
| | hot press | | | | | | | | |
| Ex. 20 | 25.4 μm Polyimide-5/203 μm | Extruded, laminated, | 290 | 100 | 3 × 3 | 295 | 22.4 | 26 | 24 |
| | Polyimide-3 laminated at 250° C. by | then biaxially stretched | | | | | | | |

Examples 14-20 demonstrate that multilayer films have much lower CTE (<30 ppm/° C.) than the as-extruded films of the comparative examples not subjected to stretching.

### EXAMPLE 21 AND COMPARATIVE EXAMPLES 9-11

Certain films from Table 4 were laminated to roughened Cu foil using a hot press. Adhesion between Cu foil and the film was measured and the results are shown in Table 5.

TABLE 5

| Ex. or | | Lamination | Lamination | Adhesion |
|---|---|---|---|---|
| C. Ex. | Film | temp. ° C. | pressure MPa | N/m |
| C. Ex. 9 | Ex. 13 | 280 | 0.83 | <262 |
| C. Ex. 10 | Ex. 13 | 280 | 6.89 | <262 |
| C. Ex. 11 | C. Ex. 18 | 280 | 0.83 | <262 |
| Ex. 21 | Ex. 15 | 265 | 1.61 | 616 |

The biaxially stretched multilayer film of Example 15 employed in Example 21 showed significantly improved metal adhesion compared to the films employed in Comparative Examples 9-11.

### EXAMPLES 22-30 AND COMPARATIVE EXAMPLES 12-14

The radius of curvature for Cu laminates was measured and the results are reported in Table 6. The laminates were prepared using a hot press under 1.61 MPa pressure. All laminates showed a positive radius of curvature. A larger radius of curvature means the laminate is more flat. All laminates comprising biaxially stretched films provided a much more flat laminate than those laminates employing extruded film comparative examples. This observation demonstrates the importance of low CTE obtained by biaxial stretching to minimize mismatch in CTE with metal foil for reducing curl.

TABLE 6

| Ex. or C.Ex. | Film | Lamination temp. ° C. | Radius of curvature, cm |
|---|---|---|---|
| C. Ex. 12 | C. Ex. 7 | 265 | 2.1 |
| Ex. 22 | Ex. 13 | 280 | n/m |
| Ex. 23 | Ex. 14 | 280 | 5.41 |
| Ex. 24 | Ex. 15 | 280 | 3.23 |
| Ex. 25 | Ex. 15 | 265 | 4.98 |
| Ex. 26 | Ex. 16 | 280 | 5.24 |
| Ex. 27 | Ex. 17 | 280 | 3.37 |
| C. Ex. 13 | C. Ex. 8 | 280 | 1.45 |
| C. Ex. 14 | C. Ex. 8 | 265 | 2 |
| Ex. 28 | Ex. 18 | 280 | 6.6 |
| Ex. 29 | Ex. 19 | 280 | 4.75 |
| Ex. 30 | Ex. 20 | 280 | 4.27 |

### EXAMPLES 31-48

Polyimide-1 was extruded into film and biaxially stretched to 3.5×3.5 followed by relaxation and annealing at 280° C. under the conditions shown in Table 7. The data in Table 7 show that the thickness in biaxially stretched Polyimide-1 film may be controlled within a narrow range of values. The data also show that the films are biaxially stretchable to provide balanced low CTE (<35 ppm/° C.) using either simultaneous or sequential stretch modes.

TABLE 7

| | Processing Conditions | | | | | Properties | | |
|---|---|---|---|---|---|---|---|---|
| | Stretch | Stretch | | Anneal | | | CTE | CTE |
| | temp. | Rate | | time | | Thickness | MD | TD |
| Ex. # | ° C. | mm/min. | Relaxation % | min. | Mode | microns | ppm/° C. | ppm/° C. |
| 31 | 265 | 100 | 5 | 15 | Simul | 22 | 11.7 | 16.4 |
| 32 | 265 | 300 | 5 | 5 | Simul | 23 | 16.6 | 10.8 |
| 33 | 265 | 100 | 5 | 5 | Simul | 22 | 13.7 | 16.8 |
| 34 | 265 | 300 | 15 | 15 | Seq | 32 | 17.0 | 19.1 |
| 35 | 270 | 200 | 10 | 10 | Simul | 21 | 18.0 | 22.8 |
| 36 | 265 | 100 | 15 | 5 | Simul | 24 | 19.9 | 15.7 |
| 37 | 275 | 300 | 15 | 5 | Simul | 16 | 22.7 | 22.5 |
| 38 | 265 | 100 | 5 | 15 | Simul | 20 | 13.8 | 17.3 |
| 39 | 275 | 100 | 5 | 5 | Seq | 14 | 33.9 | 31.4 |
| 40 | 265 | 300 | 15 | 5 | Simul | 23 | 18.3 | 20.5 |
| 41 | 275 | 100 | 15 | 5 | Simul | 12 | 23.3 | 29 |
| 42 | 275 | 300 | 15 | 15 | Simul | 28 | 31.1 | 21.3 |
| 43 | 265 | 300 | 15 | 15 | Seq | 32 | 17.4 | 16.0 |
| 44 | 275 | 100 | 5 | 5 | Seq | 17 | 25.9 | 44.5 |
| 45 | 275 | 300 | 15 | 15 | Simul | 16 | 15.6 | 27.9 |
| 46 | 270 | 200 | 10 | 10 | Seq | 26 | 21.2 | 26.7 |
| 47 | 265 | 100 | 15 | 5 | Simul | 23 | 10.1 | 15.4 |
| 48 | 275 | 300 | 5 | 5 | Simul | 17 | 30 | 14.0 |

### EXAMPLES 49-69

Blends of Polyimide-1 and Polyimide-6 were extrusion compounded into pellets followed by extrusion into film. Films were biaxially stretched to 3.5×3.5 followed by relaxation and annealing at 280° C. under the conditions shown in the table. The data in Table 8 show that the thickness in biaxially stretched film of a Polyimide-1 blend with Polyimide-6 may be controlled within a narrow range of values. The data also show that the films are biaxially stretchable to provide balanced low CTE (<35 ppm/° C.) using either simultaneous or sequential stretch modes.

TABLE 8

| | | Processing Conditions | | | | | Properties | | |
|---|---|---|---|---|---|---|---|---|---|
| | | Stretch | Stretch | | Anneal | | | CTE | CTE |
| | wt. % | temp. | Rate | | time | | Thickness | MD | TD |
| Ex. # | PI-6 | ° C. | mm/min. | Relaxation % | min. | Mode | microns | ppm/° C. | ppm/° C. |
| 49 | 2.5 | 285 | 100 | 15 | 5 | Simul | 16 | 30.5 | 26.3 |
| 50 | 2.5 | 285 | 300 | 5 | 5 | Seq | 25 | 24.3 | 22.8 |
| 51 | 2.5 | 275 | 300 | 5 | 15 | Simul | 18 | 9.9 | 15.5 |
| 52 | 5 | 285 | 100 | 5 | 5 | Seq | 24 | 25.9 | 37.5 |
| 53 | 2.5 | 275 | 100 | 5 | 15 | Seq | 25 | 17.1 | 24.4 |
| 54 | 2.5 | 285 | 300 | 15 | 15 | Seq | 28 | 26.0 | 27.2 |
| 55 | 5 | 280 | 200 | 10 | 10 | Simul | 20 | 9.7 | 17.5 |
| 56 | 5 | 275 | 300 | 5 | 15 | Seq | 20 | 18.3 | 25.6 |
| 57 | 5 | 285 | 100 | 5 | 15 | Simul | 13 | 15.1 | 19.9 |
| 58 | 5 | 280 | 200 | 10 | 10 | Seq | 24 | 19.5 | 25.7 |
| 59 | 5 | 285 | 100 | 5 | 15 | Simul | 18 | 20 | 22.9 |
| 60 | 5 | 275 | 100 | 15 | 5 | Seq | 30 | 24.8 | 18.5 |
| 61 | 2.5 | 275 | 100 | 15 | 15 | Simul | 22 | 15.6 | 20.2 |
| 62 | 5 | 275 | 100 | 15 | 5 | Seq | 28 | 18.8 | 25.9 |
| 63 | 2.5 | 275 | 100 | 5 | 5 | Simul | 19 | 13.9 | 11.5 |
| 64 | 2.5 | 285 | 300 | 15 | 15 | Seq | 27 | 36.8 | 38.3 |
| 65 | 2.5 | 285 | 300 | 5 | 5 | Seq | 21 | 28.5 | 19.3 |
| 66 | 2.5 | 275 | 100 | 5 | 15 | Seq | 29 | 15.9 | 15.9 |
| 67 | 2.5 | 275 | 300 | 15 | 5 | Simul | 18 | 13.4 | 17.8 |
| 68 | 2.5 | 280 | 200 | 10 | 10 | Seq | 22 | 17 | 23.5 |
| 69 | 2.5 | 280 | 200 | 10 | 10 | Simul | 20 | 13.9 | 13.1 |

### EXAMPLE 70

Biaxially stretched Polyimide-1 film from Example 1 is thermally laminated to copper foil using a hot press. An adhesive layer is interposed between the Polyimide-1 film and the copper foil before lamination. The laminate exhibits good adhesion between layers.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and published articles cited herein are incorporated herein by reference.

1. A biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm.

2. The multilayer film of claim 1, comprising at least three layers and having the structure A-B-A.

3. The multilayer film of claim 1, wherein the crystallizable and amorphous polyimides comprise those with structural units formally derived from (i) a dianhydride selected from the group consisting of bisphenol-A dianhydride, oxydiphthalic anhydride, benzophenone tetracarboxylic dianhydride, biphenyl tetracarboxylic dianhydride, pyromellitic dianhydride, and mixtures thereof and (ii) a diamine selected from the group consisting of meta-phenylenediamine, para-phenylenediamine, oxydianiline, diaminodiphenylsulfone, 1,3-bis(3-aminophenoxy)benzene, 1,3-bis(4-aminophenoxy)benzene, 4,4′-bis(3-aminophenoxy)biphenyl, 4,4′-bis(4-aminophenoxy)biphenyl, bis(aminophenoxy)benzophenone, and mixtures thereof.

4. The multilayer film of claim 1, wherein the amorphous polymer comprises a polyetherimide selected from the group consisting of those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, those with structural units derived from diaminodiphenylsulfone and bisphenol-A dianhydride, and mixtures thereof.

5. The multilayer film of claim 1, wherein the crystallizable polymer comprises a polyimide selected from the group consisting of those with structural units derived from 3,4-diaminodiphenylether and 4,4-oxydiphthalic anhydride, those with structural units derived from 4,4′-bis(3-aminophenoxy)biphenyl and pyromellitic dianhydride, and mixtures thereof.

6. The multilayer film of claim 1, wherein the difference in CTE in the transverse direction differs from the CTE in the machine direction by less than about 15 ppm/° C.

7. A biaxially oriented multilayer film comprising layers having the structure A-B or A-B-A, wherein A and B represent separate layers at least one of which layers comprises a polyimide having a Tg of greater than about 200° C., wherein the film has a CTE of less than 35 ppm/20 C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, the thickness of the film is in a range of between 5 μm and 125 μm, and the difference in CTE in the transverse direction differs from the CTE in the machine direction by less than about 15 ppm/° C., wherein the amorphous polymer comprises a polyetherimide selected from the group consisting of those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, those with structural units derived from diaminodiphenylsulfone and bisphenol-A dianhydride, and mixtures thereof, and wherein the crystallizable polymer comprises a polyimide selected from the group consisting of those with structural units derived from 3,4-diaminodiphenylether and 4,4-oxydiphthalic anhydride, those with structural units derived from 4,4′-bis(3-aminophenoxy)biphenyl and pyromellitic dianhydride, and mixtures thereof.

8. A biaxially oriented monolithic film comprising a polyimide with structural units formally derived from 3,4-diaminodiphenylether and 4,4-oxydiphthalic anhydride.

9. The monolithic film of claim 8, wherein the difference in CTE in the transverse direction differs from the CTE in the machine direction by less than about 15 ppm/° C.

10. An article comprising the multilayer film of claim 1.

11. An article comprising the multilayer film of claim 7.

12. An article comprising the monolithic film of claim 8.

13. A method to make a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, the thickness of the film is in a range of between 5 μm and 125 μm, and the difference in CTE in the transverse direction differs from the CTE in the machine direction by less than about 15 ppm/° C.,
wherein the method comprises the steps of (i) assembling a multilayer A-B or A-B-A film, (ii) biaxially stretching the multilayer film simultaneously or sequentially, and (iii) relaxing and annealing the film.

14. The method of claim 13, wherein the crystallizable and amorphous polyimides comprise those with structural units formally derived from (i) a dianhydride selected from the group consisting of bisphenol-A dianhydride, oxydiphthalic anhydride, benzophenone tetracarboxylic dianhydride, biphenyl tetracarboxylic dianhydride, pyromellitic dianhydride, and mixtures thereof and (ii) a diamine selected from the group consisting of meta-phenylenediamine, para-phenylenediamine, oxydianiline, diaminodiphenylsulfone, 1,3-bis(3-aminophenoxy)benzene, 1,3-bis(4-aminophenoxy)benzene, 4,4′-bis(3-aminophenoxy)biphenyl, 4,4′-bis(4-aminophenoxy)biphenyl, bis(aminophenoxy)benzophenone, and mixtures thereof.

15. The method of claim 13, wherein the multilayer film comprises at least three layers and comprises the structure A-B-A.

16. The method of claim 13, wherein the layers are assembled by coextrusion.

17. The method of claim 13, wherein the layers are independently extruded and then assembled by thermal lamination.

18. The biaxially oriented multilayer film made by the method of claim 13.

19. A laminate comprising (i) a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm, and (ii) a conductive layer, wherein the conductive layer is in contact with the layer A of the multilayer film.

20. The laminate of claim 19, wherein the multilayer film comprises at least three layers and comprises the structure A-B-A and the conductive layer is in contact with at least one layer A of the multilayer film.

21. The laminate of claim 19, wherein the crystallizable and amorphous polyimides comprise those with structural units formally derived from (i) a dianhydride selected from the group consisting of bisphenol-A dianhydride, oxydiphthalic anhydride, benzophenone tetracarboxylic dianhydride, biphenyl tetracarboxylic dianhydride, pyromellitic dianhydride, and mixtures thereof and (ii) a diamine selected from the group consisting of meta-phenylenediamine, para-phenylenediamine, oxydianiline, diaminodiphenylsulfone, 1,3-bis(3-aminophenoxy)benzene, 1,3-bis(4-aminophenoxy)benzene, 4,4′-bis(3-aminophenoxy)biphenyl, 4,4′-bis(4-aminophenoxy)biphenyl, bis(aminophenoxy)benzophenone, and mixtures thereof.

22. The laminate of claim 19, wherein the amorphous polymer comprises a polyetherimide selected from the group consisting of those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, those with structural units derived from diaminodiphenylsulfone and bisphenol-A dianhydride, and mixtures thereof.

23. The laminate of claim 19, wherein the crystallizable polymer comprises a polyimide selected from the group consisting of those with structural units derived from 3,4-diaminodiphenylether and 4,4-oxydiphthalic anhydride, those with structural units derived from 4,4′-bis(3-aminophenoxy)biphenyl and pyromellitic dianhydride, and mixtures thereof.

24. The laminate of claim 19, wherein the conductive layer comprises a metal foil selected from the group consisting of copper, zinc, brass, chrome, nickel, aluminum, stainless steel, iron, gold, silver, titanium, combinations thereof, and alloys thereof.

25. The laminate of claim 19, wherein the film or the conductive layer or both is pretreated by (i) chemical treatment with a silane, a passivation agent, a cleaning agent, an anti-oxidant, or an etching agent, or capping with a tie-coat of at least one other metal, or (ii) physical treatment by flame treatment, plasma or corona discharge, laser etching, mechanical cleaning, mechanical roughening, or heat treating.

26. The laminate of claim 19, wherein the difference in CTE between the multilayer film and the conductive layer is less than about 30 ppm/° C.

27. The laminate of claim 19, further comprising at least one adhesive layer between the layers A-B and the conductive layer.

28. A laminate comprising (i) a biaxially oriented multilayer film comprising layers having the structure A-B or A-B-A, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1.5 and 1:100, the thickness of the film is in a range of between 5 μm and 125 μm, and the difference in CTE in the transverse direction differs from the CTE in the machine direction by less than about 15 ppm/° C., wherein the amorphous polymer comprises a polyetherimide selected from the group consisting of those with structural units derived from bisphenol-A dianhydride and meta-phenylenediamine, those with structural units derived from p-phenylenediamine and bisphenol-A dianhydride, those with structural units derived from diaminodiphenylsulfone and 4,4-oxydiphthalic anhydride, those with structural units derived from diaminodiphenylsulfone and bisphenol-A dianhydride, and mixtures thereof, and wherein the crystallizable polymer comprises a polyimide selected from the group consisting of those with structural units derived from 3,4-diaminodiphenylether and 4,4-oxydiphthalic anhydride, those with structural units derived from 4,4′-bis(3-aminophenoxy)biphenyl and pyromellitic dianhydride, and mixtures thereof, and (ii) a conductive layer comprising a metal foil selected from the group consisting of copper, zinc, brass, chrome, nickel, aluminum, stainless steel, iron, gold, silver, titanium, combinations thereof, and alloys thereof, wherein the conductive layer is in contact with at least one layer A of the multilayer film, and wherein the difference in CTE between the multilayer film and the conductive layer is less than about 30 ppm/° C.

29. A laminate comprising (i) a biaxially oriented monolithic film comprising a polyimide with structural units formally derived from 3,4-diaminodiphenylether and 4,4-oxydiphthalic anhydride, and (ii) a conductive layer.

30. The laminate of claim 29, wherein the conductive layer comprises a metal foil selected from the group consisting of copper, zinc, brass, chrome, nickel, aluminum, stainless steel, iron, gold, silver, titanium, combinations thereof, and alloys thereof.

31. The laminate of claim 29, wherein the film or the conductive layer or both is pretreated by (i) chemical treatment with a silane, a passivation agent, a cleaning agent, an anti-oxidant, or an etching agent, or capping with a tie-coat of at least one other metal, or (ii) physical treatment by flame treatment, plasma or corona discharge, laser etching, mechanical cleaning, mechanical roughening, or heat treating.

32. The laminate of claim 29, wherein the difference in CTE between the monolithic film and the conductive layer is less than about 30 ppm/° C.

33. An article comprising the laminate of claim 19.

34. An article comprising the laminate of claim 28.

35. An article comprising the laminate of claim 29.

36. A method for preparing a laminate comprising (i) a biaxially oriented multilayer film comprising at least two layers A-B, wherein A and B represent separate layers at least one of which layers comprises a polyimide having a Tg of greater than about 200° C., wherein the film has a CTE of less than 35 ppm/° C., and wherein A comprises 60 wt. %-100 wt. % of amorphous polymer with 0 wt. %-40 wt. % of crystallizable polymer, and B comprises 60 wt. %-100 wt. % crystallizable polymer with 0 wt. %-40 wt. % amorphous polymer, the relative thicknesses of layer A to layer B are in a ratio in a range of between 1:5 and 1:100, and the thickness of the film is in a range of between 5 μm and 125 μm, and (ii) a conductive layer comprising a metal selected from the group consisting of copper, zinc, brass, chrome, nickel, aluminum, stainless steel, iron, gold, silver, titanium, combinations thereof, and alloys thereof,
wherein the method comprises thermally laminating the multilayer film and a metal foil, or metallizing the multilayer film using vacuum deposition or electrodeposition, wherein the metal is in contact with the layer A of the multilayer film.
